(19) United States
(12) Patent Application Publication
(10) Pub. No.: US 2023/0244561 A1
(43) Pub. Date: Aug. 3, 2023

(54) LOCALIZATION OF TELEMETRY ISSUES BASED ON LOGICAL DATA FLOWS

(71) Applicant: Cisco Technology, Inc., San Jose, CA (US)

(72) Inventors: Mirko RACA, Lausanne 26 (CH); Lorenzo GRANAI, Crissier (CH); Romain LETEURTRE, Pully (CH); Yann Loris MENTHA, Preverenges (CH)

(21) Appl. No.: 17/748,663

(22) Filed: May 19, 2022

Related U.S. Application Data
(60) Provisional application No. 63/306,190, filed on Feb. 3, 2022.

(51) Int. Cl. G06F 11/07; G06F 11/34; G06N 7/00

(52) U.S. Cl. CPC G06F 11/079; G06F 11/3409; G06N 7/005

(57) ABSTRACT

In one embodiment, an illustrative method herein may comprise: determining, by a process, a directed acyclic graph that defines pathways of telemetry metrics for a given observed system; processing, by the process, telemetry metrics received from distributed sources to detect and localize a problem from the telemetry metrics; consulting, by the process, the directed acyclic graph to find one or more common pathways of the directed acyclic graph that relate to the problem against all other pathways of the directed acyclic graph to establish a reduced telemetry search space corresponding to the one or more common pathways; and enabling, by the process, a root cause analysis operation for the problem based on the reduced telemetry search space.

### RELATED APPLICATION

This application claims priority to U.S. Prov. Appl. Ser. No. 63/306,190, filed Feb. 3, 2022, entitled LOCALIZATION OF TELEMETRY ISSUES BASED ON LOGICAL DATA FLOWS, by Raca, et al., the contents of which are incorporated herein by reference.

### TECHNICAL FIELD

The present disclosure relates generally to computer systems, and, more particularly, to localization of telemetry issues based on logical data flows.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, in a complex telemetry scenario, a number of metrics are created from a source (e.g., device) and are transformed over several collection and transmission agents (e.g., on-prem devices, cloud collector, ETL data managing processes, etc.) before they are used in reports. The complexity of such systems poses a debugging and reproduction challenge which slows down the repairs and leaves telemetry data in an unreliable state for long periods of time. The problem dimensionality increases when considering multiple distributed data sources.

Isolated profiling of each metric (statistical attributes, range checks) can be used for detecting issues, but given the distributed location of devices which are collecting/sending the metrics one can’t easily access and debug once the systems have been deployed with the customers, so one has to rely on observational data. The first question becomes how to meaningfully organize and store meta-data in order to be able to quickly identify telemetry corrupting step or combination of factors (e.g. network elements, software versions, configurations) which cause the mis-reporting.

The second question (once the corrupt metric is identified and meta-data is available) is - can one automatically localize the source of issues without going through the process of reproduction and debugging effort that can be difficult to orchestrate in a complex deployment scenario which took several development teams to develop. Ideally it would be best to narrow down the error location and present the team maintaining the component with all the contextual information needed for understanding and reproducing the issue.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of a simplified telemetry depicting main stages of processing;

FIG. 5 illustrates an example table classifying various metrics as erroneous; and

FIG. 6 illustrates an example of data flows according to one or more embodiments of the techniques herein; and

FIG. 7 illustrates an example simplified procedure for localization of telemetry issues based on logical data flows according to one or more embodiments of the techniques herein.

### DESCRIPTION OF EXAMPLE EMBODIMENTS

### Overview

According to one or more embodiments of the disclosure, techniques are directed herein to localization of telemetry issues based on logical data flows. In particular, the techniques herein consider the case of telemetry, when multiple metrics are being sent from a large number of deployments, and are being processed at different locations by different software agents, and specifically build profiles for each metric (called data flow) in the form of directed graphs where nodes represent software/hardware resources and directed edges show the “processing path” a metric takes between them until it is stored. When one detects an issue in a metric (e.g., either because the values deviates from its statistical profile, or because the value is not being reported), the techniques herein can use the data flow information to compare which graph nodes (metric properties) are shared with other corrupt metrics (and differ from valid metrics received) and localize the bug, cutting down debugging time across teams, eliminating accumulation of corrupt data and stopping invalid metrics from being used in business decisions.

Specifically, in one embodiment, an illustrative method herein may comprise: determining, by a process, a directed acyclic graph that defines pathways of telemetry metrics for a given observed system; processing, by the process, telemetry metrics received from distributed sources to detect and localize a problem from the telemetry metrics; consulting, by the process, the directed acyclic graph to find one or more common pathways of the directed acyclic graph that relate to the problem against all other pathways of the directed acyclic graph to establish a reduced telemetry search space corresponding to the one or more common pathways; and enabling, by the process, a root cause analysis operation for the problem based on the reduced telemetry search space.

Other embodiments are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

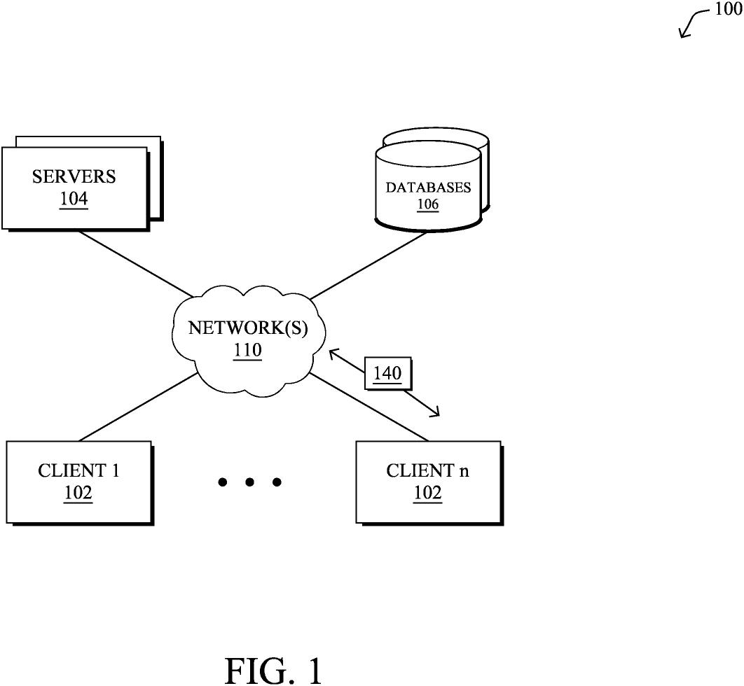

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user’s data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

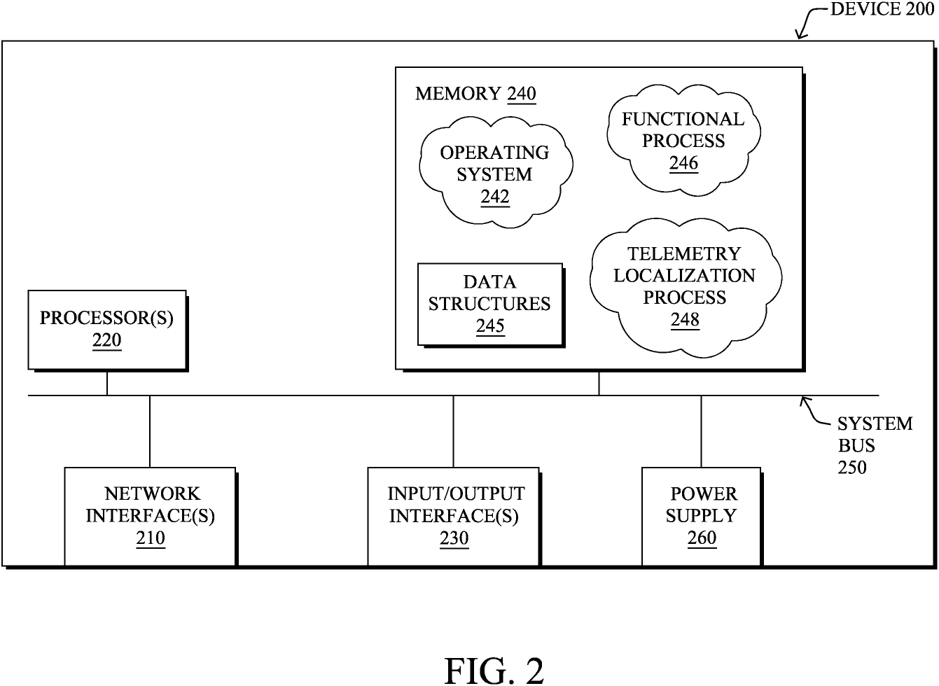

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “telemetry localization” process 248, as described herein. Notably, functional processes 246, when executed by processor(s) 220, cause each particular device 200 to perform the various functions corresponding to the particular device’s purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### -- Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user’s data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer’s own internal IT network (e.g., the customer’s enterprise IT network), a user’s client device, and/or intermediate network providers between the user’s client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

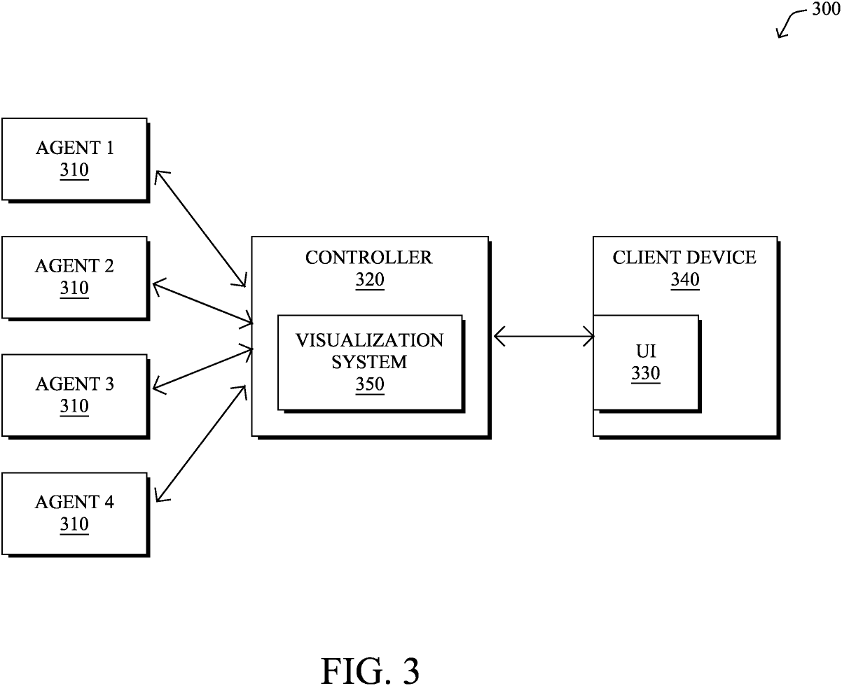

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer’s network), and endpoint agents, which may be a different version of the previous agents that is installed on actual users’ (e.g., employees’) devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they’re interested in having visibility into, whether it’s visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page -i.e., the main document along with all other components that are included in the page), or Transaction tests (e.g., same as a Page Load, but also performing multiple tasks/steps within the page - e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application’s interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### -- Localization of Telemetry Issues Based on Logical Data Flows --

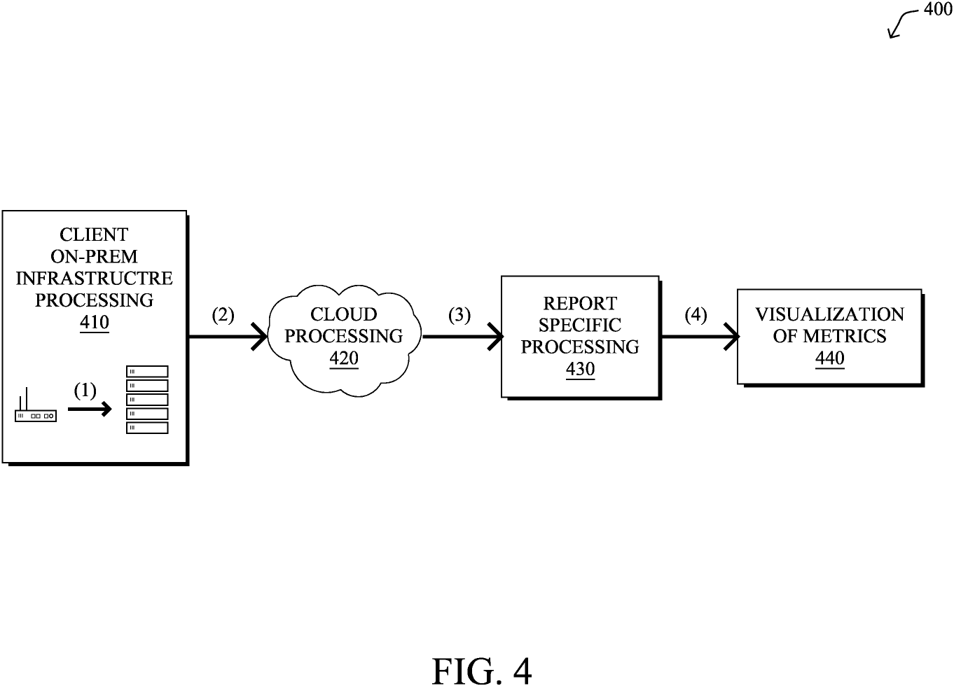

A modern ETL (extract, transform, load) telemetry channel reports hundreds of metrics collected over several distributed processing steps, run on a diverse set of devices. A simplified telemetry example 400 is shown in FIG. 4, depicting main stages of processing:
Generation of metrics and local aggregation in the client’s on-premises deployment (client on-prem infrastructure processing 410).
Cloud processing collection of metrics, handling load balancing, consistency and storage in its raw form (cloud processing 420).
Processing of the metrics specific to the report’s or visualization’s needs (report specific processing 430).
Final representation of the metrics in the raw or aggregated form (visualization of metrics 440).
The metrics can vary on a number of attributes:
1. The source of the metric might be different (e.g., one reporting about used bandwidth of the individual AP, another number of wireless clients served by the WLC);
2. Metrics might be deployed on different versions of software (e.g., Metric-11 released on DNAC 1.2, Metric-12 added on DNAC 1.3);
3. Metrics can use different transmission channels (e.g., one is coming over REST API, another over NETCONF);
4. The same metric can come from different versions of reporting software given that our telemetry endpoints do not upgrade uniformly.

The problem with this, however, is that if an issue is detected with one of the metrics (either because values are missing or values are detected as outliers), understanding the source of the problem is very time consuming and difficult to organize across multiple sites and teams. Due to complex collection structure (distributed systems, remote deployments) reproduction of issues is also becoming increasingly difficult. There is a real need for an automated way to detect and localize invalid metrics. This should also be able to scale with the increasing number of metrics.

A second big obstacle in the error localization is that one can never know beforehand all parameters relevant to the manifestation of the error. When a software error (e.g., crash) occurs, developers can hope that they put in all needed information in the logs and error reports in order to recreate the issue, but that available information set is biased - either one records for each metric value all the properties of the system generating it (generally impossible) or one relies on previous experience that they will record relevant indicators to find the error (though, if they knew beforehand what would cause the error - the error arguably wouldn’t exist).

Unlike with crashes, with invalid telemetry error logs are not generated because it would be an unmanageable amount of meta-data which would be recorded for both valid and invalid metrics, in order to compare the conditions (properties of the systems generating the metrics) between the two.

The techniques herein, therefore, provide for localization of telemetry issues based on logical data flows. In particular, the techniques herein consider the case of telemetry, when multiple metrics are being sent from a large number of deployments, and are being processed at different locations by different software agents, and specifically build profiles for each metric (called data flow) in the form of directed graphs where nodes represent software/hardware resources and directed edges show the “processing path” a metric takes between them until it is stored. When one detects an issue in a metric (e.g., either because the values deviates from its statistical profile, or because the value is not being reported), the techniques herein can use the data flow information to compare which graph nodes (metric properties) are shared with other corrupt metrics (and differ from valid metrics received) and localize the bug, cutting down debugging time across teams, eliminating accumulation of corrupt data and stopping invalid metrics from being used in our business decisions.

Notably, previous attempts to address these issues have fallen short for a number of reasons.

First, regarding error localization, current techniques concerning networking telemetry error localization do not focus on logical location of the error (i.e., which processing step is causing the issue), but rather with the physical location of the interruption/interference. Similarity can be drawn with grouping of issues in error logs as in other current techniques, but the domain of application is different, and contrast set mining is not addressing the distributed nature of the errors.

Secondly, regarding error detection, purely statistical approaches detect univariate and multivariate outliers through the use of boxplots and distances to identify statistical outliers in a medical study. Machine Learning based models implement anomaly detection by sometimes extending more common statistical methods such as Principal Component Analysis (PCA) or Kth nearest neighbors.

Although these methods yield good results, they are often too data-specific and time-consuming to be used in a more generic and time-efficient ETL (Extract-Transform-Load) data pipeline. For instance, one known framework learns to generalize the user-provided error detection/correction examples to the rest of dataset, and is effective but requires a semi-supervised user interaction. Another known generic framework for data profiling and testing requires that the outlier characterization is user-defined, and the framework itself does not offer complex outlier detection methods apart from custom user-defined functions. Many other data profiling tools exist, but rarely offer more complex analysis on input data and don’t consider the whole data pipeline to potentially also locate the inconsistencies.

As an example of an approach based on existing techniques, the most natural data representation consists in a relational view of the data, where rows correspond to a set of selected metrics and columns represent categorical metadata-related attributes (these columns correspond to the nodes in the following DAG approach). A special Boolean field in this table is reserved for error labeling: it is set to true when the corresponding metric is classified as erroneous according to some well-defined criteria (e.g. missing values). The task therefore consists in isolating those meta-data attributes whose values significantly co-occur with the positive error label. Contrast set learning algorithms represent a valid way to tackle this problem.

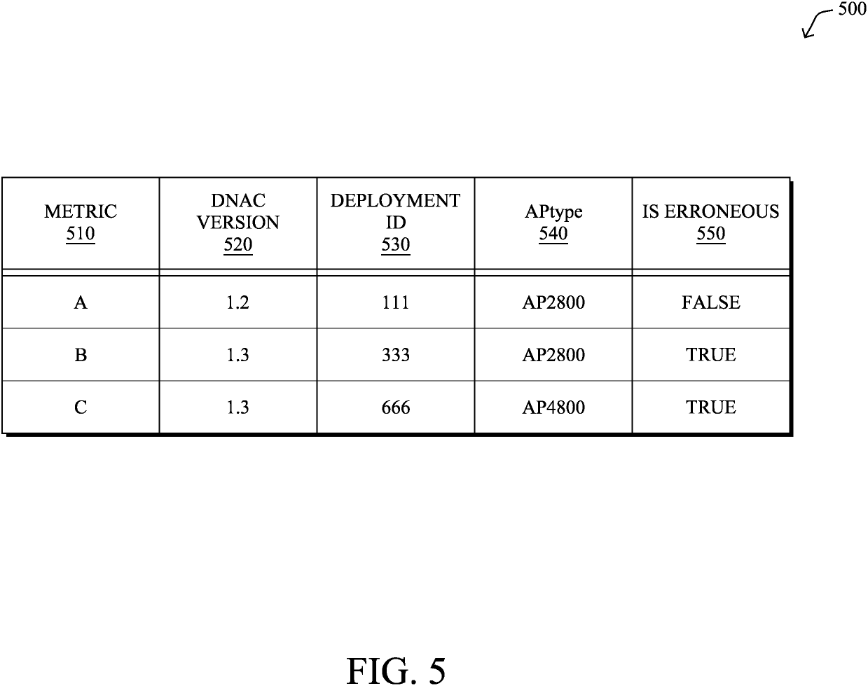

Illustrating the approach above is table 500 in FIG. 5, where with a pool of three metrics 510 A, B and C, where B and C only are classified as erroneous (e.g., a “true” value in the “Is erroneous” column 550. (We restrain the example to three metadata attributes for illustration purposes: DNAC version 520, deployment identifier 530, and type of access point, APType 540.) One can readily notice that the characteristics mostly occurring among corrupted metrics correspond to a specific version of DNAC, therefore providing a potential source for the detected error.

Operationally, therefore, the techniques herein provide a way of mapping a metric to its Data Flow, which records meta-data on how metrics are generated and how the components which are generating them interact.

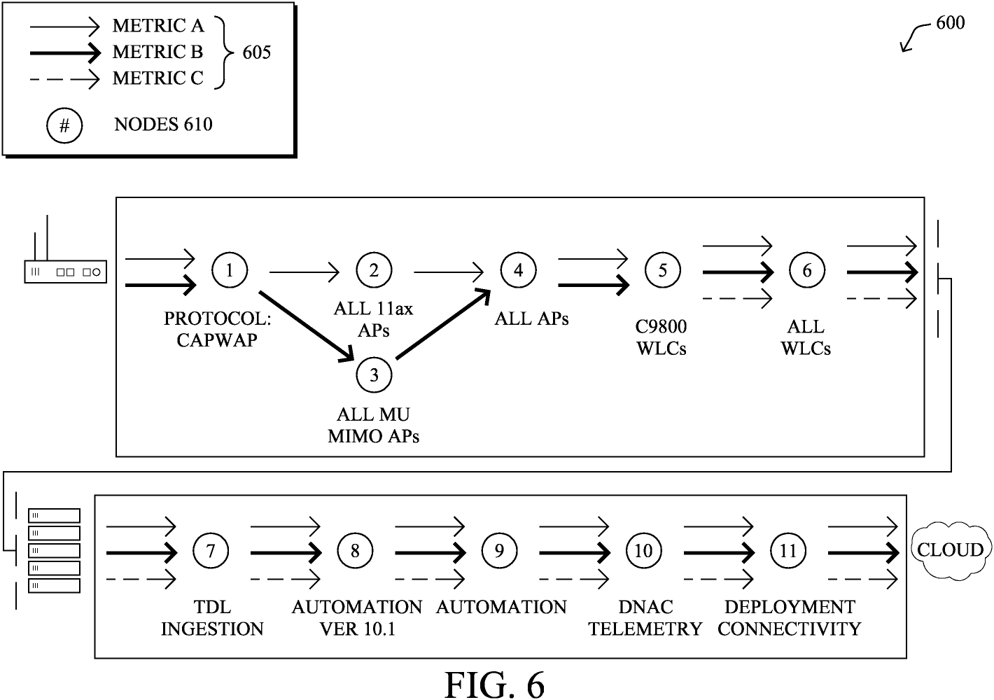

FIG. 6 illustrates an example 600 of data flows 605 (e.g., for Metrics A, B, C) according to the techniques herein. Note that this representation differs from a standard diagram of physical pipeline nodes through which the data flows. Here, data flow is a DAG (directed acyclic graph) that models each metric through a set of nodes 610 (e.g., #’s 1-11) that influence its value. The nodes do not represent only physical parts of the flow, but any attribute that can be shared with other metrics (e.g., software component, collection mechanism, software version, presence of device types, configuration options of the deployment, etc.). As shown, for example certain nodes may be based on wireless access network attributes (e.g., nodes 1-6), and other nodes may be based on router-based configurations (e.g., nodes 7-11), demonstrating how each node is not limited to the physical topology components (e.g., simply a wireless access point and a router), but instead to each attribute that may affect a metric, accordingly. Note that the DAG may be built as the telemetry collection configuration is built (e.g., manual encoding during development), or may be dynamically discovered through a variety of behavioral monitoring systems (e.g., scanning metadata of telemetry data traffic to determine physical and/or logical attributes associated with the telemetry data).

To illustrate the concept of data flows, the present disclosure provides a simplified example data flows for three metrics:
Metrics A, B, C are collected on on-prem, but with different data sources:
   ◯ metrics A and B are originating from AP devices and are collected through Wireless Controllers and DNAC telemetry appliance),
   ◯ metric C is collected only from “C9800” family of wireless controllers, but is reported through streaming telemetry (e.g., TDL) and DNAC Automation as well (shares nodes 5-11).
Metric A and B have the majority of the flow in common, but differ at nodes (2, 3) because they are concerned with different types of APs:
   ◯ metric A is only sent by 11ax APs,
   ◯ metric B is only sent by multi-user, multiple-input, multiple-output (MU MIMO) APs of any generation (11ac or 11ax).
Note that the techniques herein can encode specific software versions relevant for the metric creation, such as node (8) encoding the specific version of Automation service used.
Different data flows can merge into common flows as illustrated by nodes (5) and (6), which differentiate between metrics specific to C9800 wireless controllers and metrics coming from any type of wireless controller.

Information in data flows can be populated automatically or manually from a number of sources, but the automatic sources may comprise:
1. software versions changes sent by telemetry;
2. device presence based on inventory telemetry;
3. ontological hierarchies of properties (e.g. presence of C9800-L is a sub-category of presence of any C9800 WLC, is a sub-category of “deployment is wireless” etc.);
4. And so on.

Regarding specific benefits of the techniques herein, to take a naive approach of handling the issue without Data Flows, one should record all properties of the system as a flat structure (thousands of additional columns/attributes) and store it along with each metric value. However, the DAG structure of data flow as described herein allows:
1. Modelling ordering of processing steps and properties and cutting down the error search space by orders of magnitude (example below).
2. Operating with a smaller number of evidences (metric values) - which is different from existing methods such as contrast set learning which has no notion of attribute interdependence and relies on statistical inference (with higher chances of false positives) - and if number of samples is too low the approach breaks down. By encoding the collection/generation structure, the techniques herein can operate with fewer samples.
3. From the previous items - algorithms using Data flows have a quicker convergence (less processing, less data to be brought into memory, less metadata to be stored).
4. Importantly, the graph structure allows the detection of unexpected (i.e., not formally modeled) interactions between processing steps of different metrics, beyond interactions that developers would think to record in a typical error log.

To illustrate the benefits with an example for detecting up-stream/down-stream localization of issues:
In case of metric A being absent, the techniques herein can automatically eliminate issues in nodes 4 and above, if metric B is present in the same deployment. The techniques herein conclude this automatically by consulting the shared nodes between data flows of metrics A and B (example of benefit #1);
In case metric A, B and C are absent at the same time, the techniques herein would localize the issue in stages 5 and above;
If an error manifests in presence of three very specific factors (e.g., 9800-80 WLC, on version 17.8 controlling AP 9130) these properties can be retrieved from the data flow description of the deployment, outputted as properties (meta-data) of valid and invalid metrics and compared automatically with algorithms such as contrast set learning, while manually this would be time consuming to track down and identify as a relevant scenario (an example of benefit #4).

Notably, the techniques herein can assemble a collection of non-homogeneous reported telemetry data/metrics, which can diverge, based on modeling anything (any metadata) that affects the telemetry data (e.g., physical and/or logical, such as software versions, number of clients on an access point, etc.). Based on the commonalities shown in the DAG, the techniques herein can identify a set of deployments that represent a particular problem with telemetry (e.g., version 1.1 instead of version 1.0), which can reduce the computation necessity of root cause analysis since there is a limited data set of data/nodes. In one embodiment, the limited data set is shared with a root cause analysis engine, while in another embodiment it may be shared with a user interface, such as to allow an administrator to click on certain nodes of interest (e.g., node 3 if the metric at issue relates to all MU MIMO APs) to provide a drill down of the underlying configurations, errors, data, and so on.

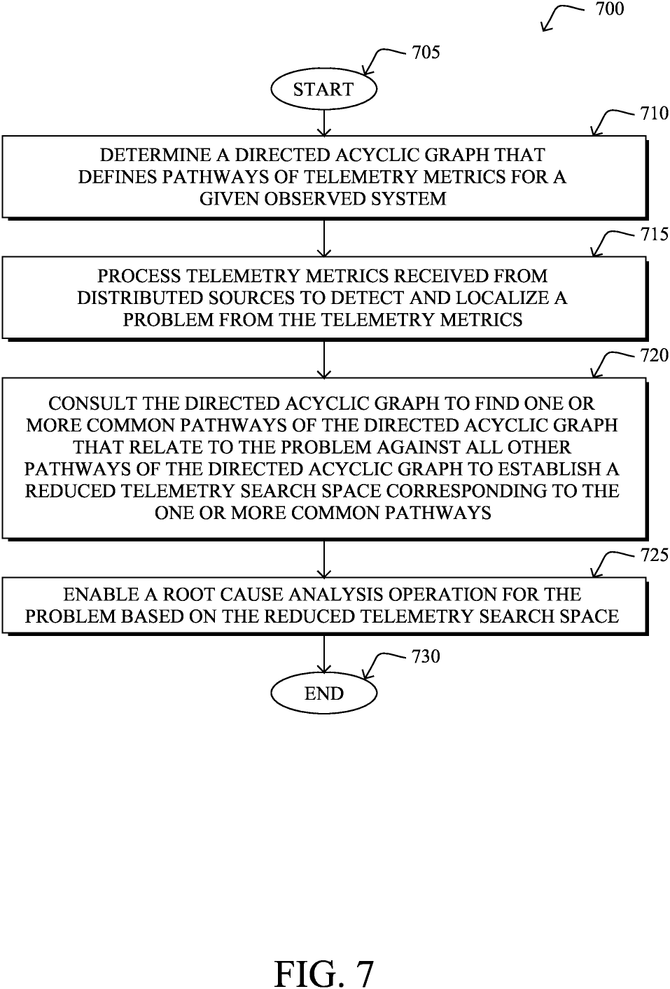

In closing, FIG. 7 illustrates an example simplified procedure 700 for localization of telemetry issues based on logical data flows in accordance with one or more embodiments described herein. For example, a non-generic, specifically configured device (e.g., device 200) may perform procedure 700 by executing stored instructions (e.g., process 248). The procedure 700 may start at step 705, and continues to step 710, where, as described in greater detail above, the process determines a directed acyclic graph that defines pathways of telemetry metrics for a given observed system. For instance, the pathways may be based on a plurality of nodes each representing an attribute (e.g., physical or logical) that influences the telemetry metrics. Notably nodes may be manually configured and/or dynamically discovered.

In step 715, the process processes telemetry metrics received from distributed sources to detect and localize a problem from the telemetry metrics. For instance, as described above, this may be based on whether particular metrics are absent from one or more specific pathways of the directed acyclic graph, and/or based on problematic metrics present on one or more specific pathways of the directed acyclic graph, and so on.

According to the techniques herein, in step 720, the process consults the directed acyclic graph to find one or more common pathways of the directed acyclic graph that relate to the problem against all other pathways of the directed acyclic graph to establish a reduced telemetry search space corresponding to the one or more common pathways, and then in step 725, the process enables a root cause analysis operation for the problem based on the reduced telemetry search space. In one embodiment, step 725 comprises providing the reduced telemetry search space to a user interface, while in another embodiment, the techniques herein may perform the actual root cause analysis operation (e.g., one or more automated processes).

The illustrative simplified procedure 700 may then end in step 730, notably with the option to continue receiving telemetry metrics, and determining affected pathways for any issues, accordingly. Other steps may also be included generally within procedure 700, e.g., as separate steps and/or as additions to steps already specifically illustrated above.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for localization of telemetry issues based on logical data flows. In particular, the techniques herein cut down debugging time across teams, eliminate accumulation of corrupt data and stop invalid metrics from being used in business decisions. As noted above, recording metrics’ metadata as a data flow (DAGs of properties) effectively encodes large number of deployment attributes which speeds-up error localization algorithms and reduces the meta-data storage. Also, data flows can encode and retrieve non-trivial connections between metric properties which would be impossible to hard-code for monitoring before-hand.

Current techniques for issue diagnosing and root cause analysis attempt to locate the source of errors within a network using physical topologies of the network. As mentioned above, however, the techniques herein establish a DAG model the data flow where each node represents an attribute, both physical and logical, that can influence the value of a particular metric (i.e., the DAG does not merely represent a physical topology). In addition, no current techniques limit a telemetry search space to only those common pathways that exhibit an issue, as described above. That is, the techniques herein reduce the data set of the telemetry processing, based on only searching those pathways within the DAG that share the issue at hand.

In still further embodiments of the techniques herein, a business impact of the telemetry issues can also be quantified. That is, because of issues related to specific applications / processes (e.g., lost traffic, slower servers, overloaded network links, etc.), various corresponding business transactions may have been correspondingly affected for those applications / processes (e.g., online purchases were delayed, page visits were halted before fully loading, user satisfaction or dwell time decreased, etc.), while other processes (e.g., on other network segments or at other times) remain unaffected. The techniques herein, therefore, can correlate the telemetry issues with various business transactions in order to better understand the effect on the business transactions, accordingly.

Illustratively, the techniques described herein may be performed by hardware, software, and/or firmware, such as in accordance with the illustrative telemetry localization process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: determining, by a process, a directed acyclic graph that defines pathways of telemetry metrics for a given observed system; processing, by the process, telemetry metrics received from distributed sources to detect and localize a problem from the telemetry metrics; consulting, by the process, the directed acyclic graph to find one or more common pathways of the directed acyclic graph that relate to the problem against all other pathways of the directed acyclic graph to establish a reduced telemetry search space corresponding to the one or more common pathways; and enabling, by the process, a root cause analysis operation for the problem based on the reduced telemetry search space.

In one embodiment, pathways are based on a plurality of nodes each representing an attribute that influences the telemetry metrics. In one embodiment, the attribute is one of either a physical attribute or a logical attribute. In one embodiment, one or more of the plurality of nodes are manually configured. In one embodiment, one or more of the plurality of nodes are dynamically discovered.

In one embodiment, enabling the root cause analysis operation comprises: providing the reduced telemetry search space to a user interface.

In one embodiment, enabling the root cause analysis operation comprises: performing the root cause analysis operation.

In one embodiment, processing telemetry metrics received from distributed sources to detect and localize the problem is based on whether particular metrics are absent from one or more specific pathways of the directed acyclic graph.

In one embodiment, processing telemetry metrics received from distributed sources to detect and localize the problem is based on problematic metrics present on one or more specific pathways of the directed acyclic graph.

According to the embodiments herein, an illustrative tangible, non-transitory, computer-readable medium herein may have computer-executable instructions stored thereon that, when executed by a processor on a computer, may cause the computer to perform a method comprising: determining a directed acyclic graph that defines pathways of telemetry metrics for a given observed system; processing telemetry metrics received from distributed sources to detect and localize a problem from the telemetry metrics; consulting the directed acyclic graph to find one or more common pathways of the directed acyclic graph that relate to the problem against all other pathways of the directed acyclic graph to establish a reduced telemetry search space corresponding to the one or more common pathways; and enabling a root cause analysis operation for the problem based on the reduced telemetry search space.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: determine a directed acyclic graph that defines pathways of telemetry metrics for a given observed system; process telemetry metrics received from distributed sources to detect and localize a problem from the telemetry metrics; consult the directed acyclic graph to find one or more common pathways of the directed acyclic graph that relate to the problem against all other pathways of the directed acyclic graph to establish a reduced telemetry search space corresponding to the one or more common pathways; and enable a root cause analysis operation for the problem based on the reduced telemetry search space.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a process, a directed acyclic graph that defines pathways of telemetry metrics for a given observed system;
processing, by the process, telemetry metrics received from distributed sources to detect and localize a problem from the telemetry metrics;
consulting, by the process, the directed acyclic graph to find one or more common pathways of the directed acyclic graph that relate to the problem against all other pathways of the directed acyclic graph to establish a reduced telemetry search space corresponding to the one or more common pathways; and
enabling, by the process, a root cause analysis operation for the problem based on the reduced telemetry search space.

2. The method as in claim 1, wherein pathways are based on a plurality of nodes each representing an attribute that influences the telemetry metrics.

3. The method as in claim 2, wherein the attribute is one of either a physical attribute or a logical attribute.

4. The method as in claim 2, wherein one or more of the plurality of nodes are manually configured.

5. The method as in claim 2, wherein one or more of the plurality of nodes are dynamically discovered.

6. The method as in claim 1, wherein enabling the root cause analysis operation comprises:
providing the reduced telemetry search space to a user interface.

7. The method as in claim 1, wherein enabling the root cause analysis operation comprises:
performing the root cause analysis operation.

8. The method as in claim 1, wherein processing telemetry metrics received from distributed sources to detect and localize the problem is based on whether particular metrics are absent from one or more specific pathways of the directed acyclic graph.

9. The method as in claim 1, wherein processing telemetry metrics received from distributed sources to detect and localize the problem is based on problematic metrics present on one or more specific pathways of the directed acyclic graph.

10. A tangible, non-transitory, computer-readable medium having computer-executable instructions stored thereon that, when executed by a processor on a computer, cause the computer to perform a method comprising:
determining a directed acyclic graph that defines pathways of telemetry metrics for a given observed system;
processing telemetry metrics received from distributed sources to detect and localize a problem from the telemetry metrics;
consulting the directed acyclic graph to find one or more common pathways of the directed acyclic graph that relate to the problem against all other pathways of the directed acyclic graph to establish a reduced telemetry search space corresponding to the one or more common pathways; and
enabling a root cause analysis operation for the problem based on the reduced telemetry search space.

11. The tangible, non-transitory, computer-readable medium as in claim 10, wherein pathways are based on a plurality of nodes each representing an attribute that influences the telemetry metrics.

12. The tangible, non-transitory, computer-readable medium as in claim 11, wherein the attribute is one of either a physical attribute or a logical attribute.

13. The tangible, non-transitory, computer-readable medium as in claim 11, wherein one or more of the plurality of nodes are manually configured.

14. The tangible, non-transitory, computer-readable medium as in claim 11, wherein one or more of the plurality of nodes are dynamically discovered.

15. The tangible, non-transitory, computer-readable medium as in claim 10, wherein enabling the root cause analysis operation comprises:
providing the reduced telemetry search space to a user interface.

16. The tangible, non-transitory, computer-readable medium as in claim 10, wherein enabling the root cause analysis operation comprises:
performing the root cause analysis operation.

17. The tangible, non-transitory, computer-readable medium as in claim 10, wherein processing telemetry metrics received from distributed sources to detect and localize the problem is based on whether particular metrics are absent from one or more specific pathways of the directed acyclic graph.

18. The tangible, non-transitory, computer-readable medium as in claim 10, wherein processing telemetry metrics received from distributed sources to detect and localize the problem is based on problematic metrics present on one or more specific pathways of the directed acyclic graph.

19. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a directed acyclic graph that defines pathways of telemetry metrics for a given observed system;
process telemetry metrics received from distributed sources to detect and localize a problem from the telemetry metrics;
consult the directed acyclic graph to find one or more common pathways of the directed acyclic graph that relate to the problem against all other pathways of the directed acyclic graph to establish a reduced telemetry search space corresponding to the one or more common pathways; and
enable a root cause analysis operation for the problem based on the reduced telemetry search space.

20. The apparatus as in claim 19, wherein pathways are based on a plurality of nodes each representing an attribute that influences the telemetry metrics.
